(19) United States
(12) Patent Application Publication
(10) Pub. No.: US 2013/0111393 A1
(43) Pub. Date: May 2, 2013

(54) MODELING REPORTS DIRECTLY FROM DATA SOURCES

(71) Applicant: Jerry John, Bangalore (IN)

(72) Inventor: Jerry John, Bangalore (IN)

(73) Assignee: SAP AG, Walldorf (DE)

(21) Appl. No.: 13/283,827

(22) Filed: Oct. 28, 2011

(51) Int. Cl. G06F 3/048

(52) U.S. Cl. 715/781

(57) ABSTRACT

A computer program and corresponding method allows for the enablement of generating modeling reports directly from data sources. A descriptive report is directly generated from existing data source objects and is regenerated based on the configuration of columns of the descriptive report that perform calculation or operations on the data of a selected column. The descriptive report is displayed in the same interface as the column configuration operations.

### FIELD OF THE INVENTION

The present invention relates to a process for modeling reports directly from data sources. The present invention further relates to a process for identifying data sources from enterprise resource planning tables and generating reports directly from the identified data sources.

### BACKGROUND INFORMATION

Data warehouses such as the SAP™ Business Information Warehouse (“SAP BW”) allow for data reporting by storing business related data in a data warehouse and later uploading the data from a corresponding operational system. Data warehouses allow for cataloguing the data and making the data available to an end user for analytics and other business uses. The business related data is identified, extracted, and loaded by the data warehouses. Business information warehouses such as SAP BW contain many structured processes that are performed in conjunction with each other to support decision making.

An extraction and loading process can extract data from a data source, transform the extracted data into a suitable form, and load the data in the data warehouse. The data is stored in the data warehouse in the form of data objects or other data repositories known as InfoCubes. When it is necessary to generate a report to the end user, the data stored in the data warehouse is accessed and presented to the end user. The end processes of the business information warehouse allow the end user to analyze and run simulations on the reported data.

FIG. 1 illustrates a diagram of traditional data modeling using SAP BW. In step 10, a source of the data is identified for modeling. Enterprise resource planning (“ERP”) software such as SAP™ ERP can potentially be a source, whereupon the data contained in ERP tables can be identified for extraction. In step 11, the BW resources are modeled by creating data and logical models, InfoCubes, and in step 12, these created BW resource models are combined with the data sources, as the data is mapped to the InfoCubes. Model reports can be created in step 13 from the InfoCubes, and in step 14 the user may receive a final end report.

Data modeling through traditional BW modeling does require a number of particular details. Foremost, it requires that the end user have a strong technical understanding of SAP BW. Moreover, because underlying BW resources need to be created, the presence of the InfoCubes may lead to a redundancy in the modeling. This could possibly slow down the speed of the data modeling and leads to an inefficient modeling system.

Subsequently, newer modeling processes have been designed which allow for streamlining the creation of model reports for end users. One such process that has been designed is through High-Performance Analytic Appliance (“HANA”) modeling. HANA modeling allows for data modeling via an in-memory computing engine where business data that is to be processed is stored in RAM instead of being read from discs or a flash drive. This may lead to a higher performance from the modeling process.

FIG. 2 illustrates a diagram of HANA modeling. In step 20, all of the possible data sources are identified for modeling. In step 21, metadata from the source are imported. This dynamically creates physical tables for extraction. This also subsequently allows for the loading of physical data with the desired content. In step 22, information models are created. These information models contain attributes, non-measurable analytic elements, and measures, which are measurable analytic elements. Information models allow for the creation of different types of views that can be presented and used for analytic decision making. Information models include an attribute view, an analytic view, and a calculation view, the latter of which is used to address complex business analytics. In step 23, model reports are created from the calculation view which manipulates the retrieved data by desired calculations and generates an end report for the end user in step 24.

Although HANA modeling allows for faster modeling than traditional BW data modeling, HANA modeling requires advanced knowledge of HANA modeling by an end user. This is increasingly difficult because both HANA modeling and traditional BW modeling are extremely technical activities which may transcend beyond the knowledge base of a simple user. A user, such as a “layman”, may not be able to use HANA or traditional BW modeling to model custom reports without communicating or explaining specific requirements to a BW developer or designer.

Thus there remains a need in the art, for a report modeler which allows for the customizability of data reports from data sources without the prerequisite knowledge or expertise of traditional BW or HANA modeling. There also remains a need in the art, for a data report modeler that is faster and more efficient in generating final end user reports.

### BRIEF DESCRIPTION OF THE DRAWINGS

FIG. 1 is a diagram of the process of traditional BW modeling.

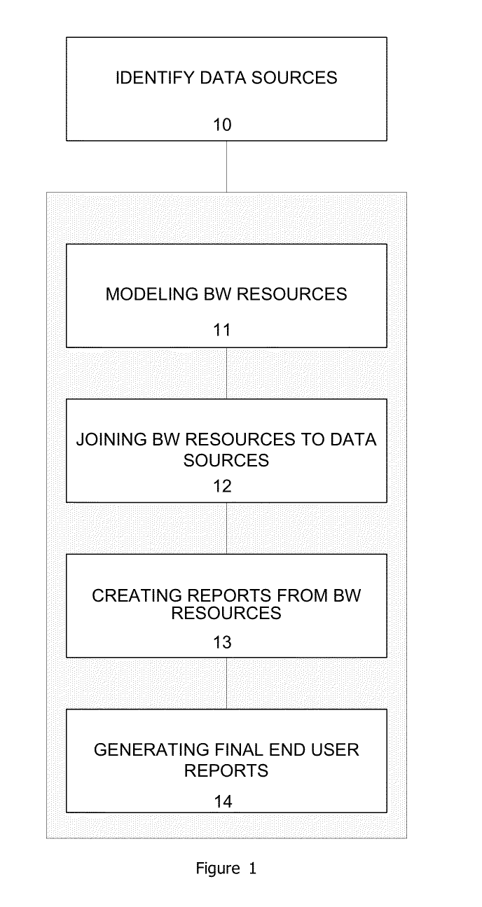

FIG. 2 is a diagram of the process of HANA modeling.

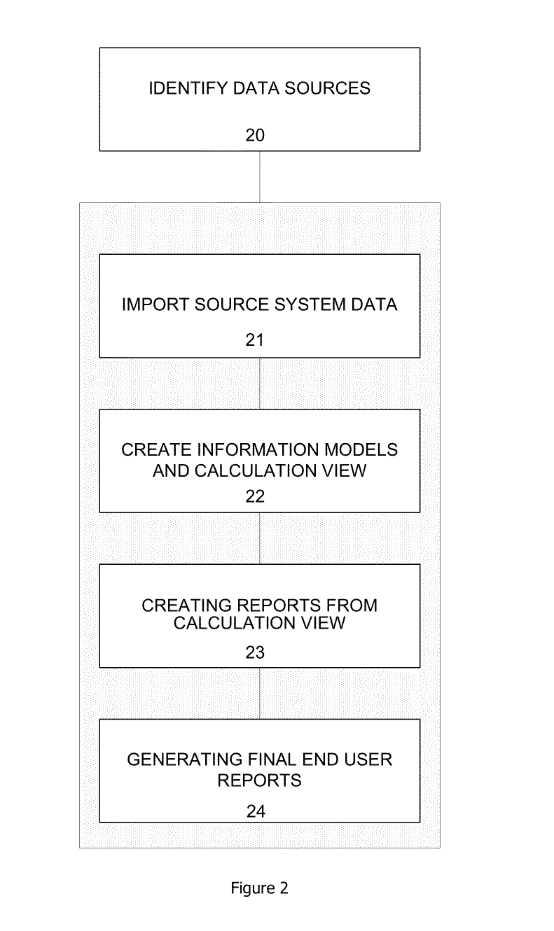

FIG. 3 is a diagram of the report modeler application during runtime according to the present invention.

FIG. 4 is a diagram of the process of the report modeler according to the present invention.

FIG. 5 is an interface of the report modeler according to the present invention.

FIG. 6 is an interface of the report modeler during the selection of a provider type according to the present invention.

### DETAILED DESCRIPTION

The subject invention will now be described in detail for specific preferred embodiments of the invention, it being understood that these embodiments are intended only as illustrative examples and the invention is not to be limited thereto.

Traditional BW and HANA modeling systems lead to redundancies by creating underlying BW resources or information models. Embodiments of the present invention provide a program executed on a processor that allows for the creation of modeling reports directly from data sources without creating underlying objects or models. The executed program further allows for the editing and inclusion of properties by a user of the modeled reports through various input fields and may be displayed on a computer or a comparable device with a displayable interface.

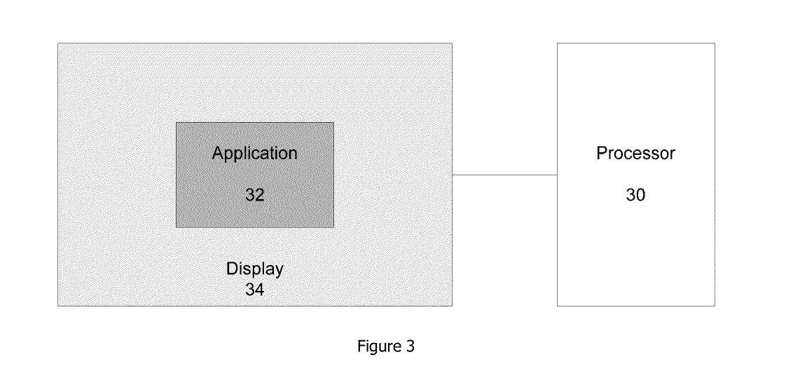

FIG. 3 illustrates a diagram of a monitor 34 displaying the application 32 of the present invention. Application 32 may be executed by processor 30 and may be displayed on monitor 34 to a user. Monitor 34 may be a computer monitor, or any other display device which may depict application 32 during execution.

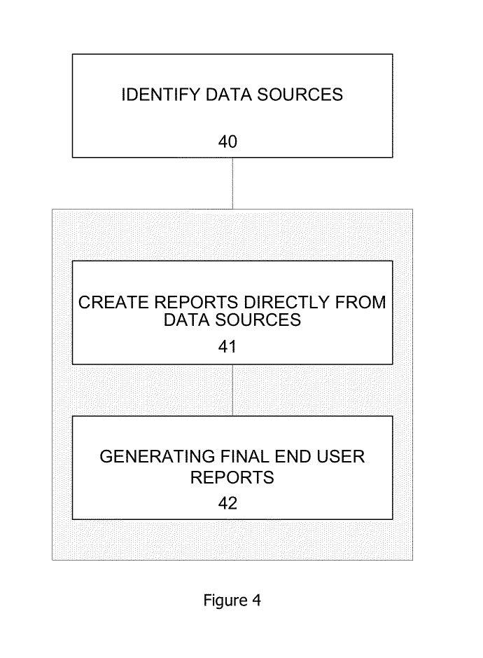

FIG. 4 illustrates the modeling report process of application 32 according to the present invention. In step 40, data sources from which the data may be extracted may be identified. Data sources may include ERP platforms where data may be extracted directly from the ERP tables. In step 41, application 32 may create descriptive reports directly from the data sources using a report modeler interface 50. Report modeler 50 may allow for a user to select data sources to load data from and may display a preview of a descriptive report for the end user based on the selected data sources. In step 42, an actual end report may be generated and displayed to the user.

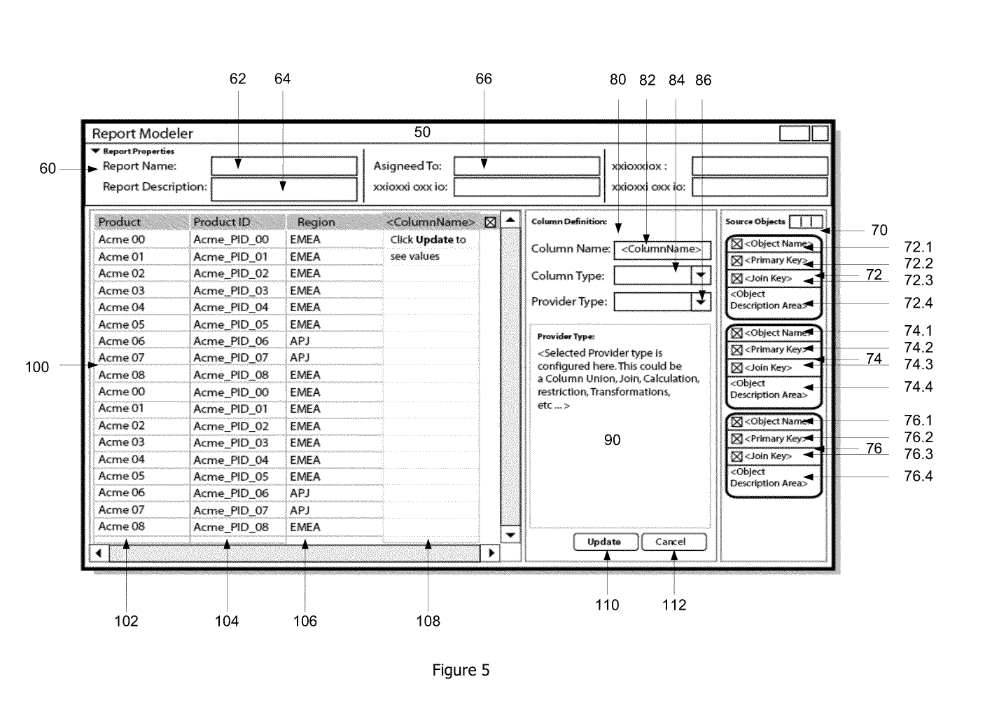

FIG. 5 illustrates report modeler interface 50 during a run-time environment. Application 32 may contain interface 50 which may display a report modeler in a window to the user. Report modeler 50 may display panel 60, which may allow a user to define the properties of the proposed descriptive report. Panel 60 may display input field headers and input fields 62, 64, and 66, which may allow for the user to input data for each respective input field. The input fields 62, 64, and 66 in panel 60 may be separated in various sections of panel 60, under separate input field headers. Input field headers for the report properties of panel 60 may correspond to properties of the descriptive report such as “Report Name”, “Report Description”, and “Assigned To”. A user may input data values corresponding to the input field headers and their respective input fields. In input field 62, a user may input a name for the desired descriptive report, while providing a description for the descriptive report in input field 64. If a descriptive report is supposed to be assigned to a specific entity, the name of this entity may be entered in input field 66. In an embodiment, report modeler 50 may contain multiple fields for inputting desired assignees.

Report modeler 50 may also contain a panel 70 that may appear below panel 60. Panel 70 may allow a user to define the source objects for which data may be extracted for the descriptive report. Panel 70 may contain multiple list boxes, 72, 74, and 76, which may list the distinct data sources for report modeler 50. In an embodiment, the number of list boxes displayed in panel 70 may be equal to the number of data sources for report modeler 50. List box 72 may contain information about a first data source object. In section 72.1, the name of the data source object may be displayed. Section 72.2 may display the primary key of the data source object in list box 72. The primary key displayed in section 72.2 may uniquely identify the data source listed in list box 72 and may be referring to an attribute of the data source. Section 72.3 may display the join key for the first data source object. The join key may be used to sort and partition the data from the first data source. List box 72 may also display a description of the first data source object in section 72.4.

In an example embodiment, report modeler 50 may have at least two data sources, and panel 70 may also display list box 74. List box 74 may be displayed below list box 72 and may be the same size and shape as list box 72. List box 74 may contain information about a second data source object. In section 74.1, the name of the second data source object may be displayed. Section 74.2 may display the primary key identifier of the data source object in list box 74. Section 74.3 may display the join key for the second data source. List box 74 may also display a description of the second data source object in section 74.4.

In an example embodiment, report modeler 50 may have at least three data sources, and panel 70 may also display list box 76. List box 76 may be displayed directly below list box 74 and may be the same size and shape as both list boxes 72 and list box 74. List box 76 may contain information about a third data source object. In section 76.1, the name of the third data source object may be displayed. Section 76.2 may display the primary key identifier of the data source object in list box 76. Section 76.3 may display the join key for the third data source. List box 76 may also display a description of the third data source object in section 76.4.

Report modeler interface 50 may also contain panel 80. Panel 80 may be displayed below panel 60 and adjacent to panel 70. Panel 80 may also have the same length as panel 70. Panel 80 may allow for a user to create and provide definitions for desired columns to be generated for the descriptive report such as columns 102, 104, 106, and 108 shown in FIG. 5. A user may use panel 80 to add new columns to the descriptive report in viewing pane 100 or to edit existing columns.

Panel 80 may contain three input field headers: “Column Name”, “Column Type”, and “Provider Type”. In input field 82, a user may input a name into the input field. The inputted column name may be the column header of the respective column in viewing pane 100. For example, in FIG. 5, the column headers “Product”, “Product ID”, and “Region” may represent inputted column names for previously input columns. Field 84 may be a drop down list that allows a user to selectively choose a column type to be displayed in the column in viewing pane 100.

In field 86, a user may selective choose a provider type from a drop down list. The selected provider type is configured and displayed in subpanel 90. Subpanel 90 may be enclosed in panel 80. A selection of a provider type may allow a user to configure the descriptive report by limiting the view to information from the data source object that the user wants to narrow for analysis. In an embodiment, the provider types may correspond to an attribute view, an analytic view, or a calculation view. The provider types listed in the drop down list in field 86 may be attributes or measures that perform the desired functionality for a user. In an embodiment, a provider type may be selected to be one of: “Simple Attribute”, “Calculated Attribute”, “Private Attribute”, “Simple Measure”, “Calculated Measure”, or “Restricted Measure”. It should be understand that the provider types should not be restricted to the examples in this embodiment.

A selection of a provider type as “Simple Attribute” may correspond to non-measurable analytical elements that are derived directly from the data itself. Columns 102, 104, and 106, which refer to the “Product”, “Product ID”, and “Region”, may be simple attributes where a selection of “Simple Attribute” is appropriate. A selection of “Calculated Attribute” may be made when performing mathematical operations on existing attributes or constants to derive a calculated attribute. Selecting “Private Attribute” as a provider type may correspond to circumstances in which an attribute is used to model a specific view (attribute, analytic, or calculation) and must be restricted to only being used within that view.

A selection by a user of a provider type of “Simple Measure” is appropriate for any measurable analytic directly derived from the data source. An example of a simple measure may be “revenue” or “expenses” which is to be displayed in a column. A selection of “Calculated Measure” by a user as a provider type may be made in instances in which calculations are performed on data from the data sources in the form of arithmetic operations or functions. For example, determining a “net loss” of a product may be an example of a calculated measure. A selection of “Restricted Measure” may be appropriately selected by a user in instances in which the user desires to filter a value based on any particular parameters. For example, a user may choose to filter the data from the source data object to only display sales that were greater than $100. This may be considered a restricted measure.

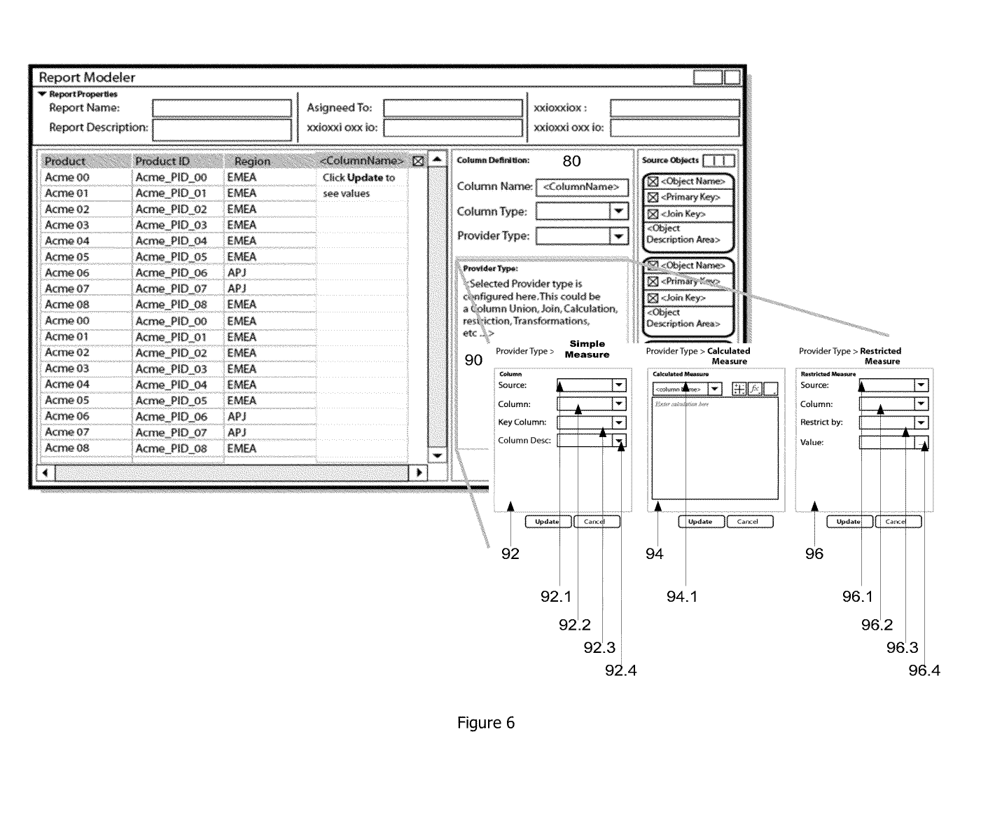

FIG. 6 illustrates multiple options for the selection type of a provider type. In particular, FIG. 6 illustrates selecting a provider type of “Simple Measure”, “Calculated Measure”, and “Restricted Measure”. It should be understood that FIG. 6 does not represent an exhaustive or limiting set of provider types. In an embodiment, the provider type may be selected in input field 86 to be “Simple Measure”. Subpanel 92 may correspond to the subpanel that is displayed in subpanel 90 when “Simple Measure” is configured as the provider type. Subpanel 92 may contained multiple input fields and field headers. Input field 92.1 may correspond to the field header “Source”. In input field 92.1, a user may select the desired data source object from a drop down list. The data source objects presented in input field 92.1 may correspond to one of the listed data source objects in panel 70.

Input field 92.2 may correspond to the field header “Column”. A user may select any newly made column from input field 82. Alternatively, a list of existing columns that have been made and displayed in viewing pane 100 may also be presented in the drop down list for input field 92.2. A user may select the desired column for display in viewing pane 100. In input field 92.3, a selection may be made from a drop down list corresponding to a “Key Column” which may allow for unique identifying of a particular row in viewing pane 100. A selection may also be made in input field 92.4 of an existing column description of one of the existing columns in viewing pane 100. This selection may be made from the drop down list in input field 92.4.

In an embodiment, the provider type may be selected in input field 86 to be “Calculated Measure”. Subpanel 94 may correspond to the subpanel that is displayed in subpanel 90 when “Calculated Measure” is configured as the provider type. Subpanel 94 may contain an input field 94.1 for the selection of a desired column name. A selection of the column may be made from a drop down list, and a user may select an existing column from viewing pane 100 or a newly made column from input field 82. Subpanel 94 may contain an additional text box in which a calculation that is to be performed on the selected column from input field 94.1 may be input into the text box. Arithmetic or function operations may be selected to be performed on the selected column by selecting an operations button or algorithm button adjacent to input field 94.1.

In an embodiment, the provider type may be selected in input field 86 to be “Restricted Measure”. Subpanel 96 may correspond to the subpanel that is displayed in subpanel 90 when “Restricted Measure” is configured as the provider type. Subpanel 96 may contain multiple input fields and field headers. Input field 96.1 may correspond to the field header “Source”. In input field 96.1, a user may select the desired data source object from a drop down list. The data source objects presented in input field 96.1 may correspond to one of the listed data source objects in panel 70.

Input field 96.2 may correspond to the field header “Column”. A user may select any newly made column from input field 82. Alternatively, a list of existing columns that have been made and displayed in viewing pane 100 may be presented in the drop down list for input field 96.2. A user may select the desired column for display in viewing pane 100. In input field 96.3, a selection may be made to restrict the entries by a specific identifier or restrictor. This may be made from selecting a restrictor from the drop down list in input field 96.3 corresponding to the “Restricted by” field header. A selection may be made in input field 96.4 of a value corresponding to the selected restrictor in input field 96.3. This selection may be made from the drop down list in input field 96.4.

Panel 80 may also contain an “Update” button 110 and a “Cancel” button 112. After a provider type is selected in input field 86, and depending on the provider type, after a selection of the relevant input fields 92.1-92.4, 94.1, or 96.1-96.4, clicking on button 110 may save the selections made by the user and refresh the autogenerated model in viewing pane 100. The column selected to be configured in panel 80 may be added and display data in accordance to the selections made in panel 80. If the selected column was edited, the edited column may be refreshed in viewing pane 100 to display the changes to the data in the selected column. Clicking on button 112 may cancel any selections made in panel 80, and no refreshing of the model in viewing pane 100 will be done. If button 112 is selected, no changes will be made to the configured column in panel 80.

Report modeler 50 may contain viewing pane 100 which may be situated adjacent to panel 80 and below panel 60. Viewing pane 100 may display a real time preview of a descriptive report based on the selected and updated columns. Updating data in the columns in panel 80 may refresh the preview in viewing pane 100. Viewing pane 100 may also contain a vertical scroll bar and a horizontal scroll bar which may allow a user to scroll and view all of the entries in all of the columns in the descriptive report, which may not fit in viewing pane 100.

Several embodiments of the invention are specifically illustrated and/or described herein. However, it will be appreciated that modifications and variations of the invention are covered by the above teachings and within the purview of the appended claims without departing from the spirit and intended scope of the invention.

1. A method for generating descriptive reports directly from data sources by an application displayed on a monitor device, the method comprising:
loading data from at least one data source object into the application, the data being arranged by a set of keys;
generating at least one column for a descriptive report based on selection of the at least one data source object and a provider type, wherein selection of the provider type configures the at least one column for analysis in the descriptive report; and
displaying the at least one new column in a viewing pane of the application, the viewing pane being refreshed after an additional column is added and configured.

2. The method according to claim 1, wherein the viewing pane displays a preview of the descriptive report.

3. The method according to claim 1, wherein the configuring of the at least one column converts data entries of the at least one column into simple attributes.

4. The method according to claim 1, wherein the configuring of the at least one column performs mathematical operations on existing attributes of the at least one column to derive calculated attributes.

5. The method according to claim 1, wherein the configuring of the at least one column restricts data entries of the at least one column to a single view of the application.

6. The method according to claim 1, wherein the configuring of the at least one column derives data entries of the at least one column into simple measures.

7. The method according to claim 1, wherein the configuring of the at least one column performs mathematical operations on data entries of the at least one column to derive calculated measures.

8. The method according to claim 1, wherein the configuring of the at least one column filters data entries of the at least one column based on a restricting value.

9. The method according to claim 1, further comprising:
updating column properties of the at least one column, wherein the viewing pane is refreshed to reflect the updated column properties of the at least one column.

10. The method according to claim 1, wherein changing the provider type of the at least one column refreshes the viewing pane to reflect an adaptation of the at least one column.

11. The method according to claim 1, wherein the viewing pane is refreshed when a user clicks an update button.

12. A non-transitory computer readable medium having a computer program which is executable by a processor for generating descriptive reports directly from data sources, the computer readable medium comprising:
an arrangement providing the following:
loading data from at least one data source object into the application, the data being arranged by a set of keys;
generating at least one column for a descriptive report based on selection of the at least one data source object and a provider type, wherein selection of the provider type configures the at least one column for analysis in the descriptive report; and
displaying the at least one new column in a viewing pane of the application, the viewing pane being refreshed after an additional column is added and configured or the at least one column is reconfigured.

13. The computer readable medium according to claim 12, wherein the viewing pane displays a preview of the descriptive report.

14. The computer readable medium according to claim 12, wherein the configuring of the at least one column converts data entries of the at least one column into simple attributes.

15. The computer readable medium according to claim 12, wherein the configuring of the at least one column performs mathematical operations on existing attributes of the at least one column to derive calculated attributes.

16. The computer readable medium according to claim 12, wherein the configuring of the at least one column restricts data entries of the at least one column to a single view of the application.

17. The computer readable medium according to claim 12, wherein the configuring of the at least one column derives data entries of the at least one column into simple measures.

18. The computer readable medium according to claim 12, wherein the configuring of the at least one column performs mathematical operations on data entries of the at least one column to derive calculated measures.

19. The computer readable medium according to claim 12, wherein the configuring of the at least one column filters data entries of the at least one column based on a restricting value.

20. The computer readable medium according to claim 12, further comprising:
updating column properties of the at least one column, wherein the viewing pane is refreshed to reflect the updated column properties of the at least one column.

21. The computer readable medium according to claim 12, wherein changing the provider type of the at least one column refreshes the viewing pane to reflect an adaptation of the at least one column.

22. The computer readable medium according to claim 12, wherein the viewing pane is refreshed when a user clicks an update button.
